(19) United States
(12) Patent Application Publication
(10) Pub. No.: US 2003/0186686 A1
(43) Pub. Date: Oct. 2, 2003

(54) Wireless data call waiting

(76) Inventors: ZhongJin Yang, Naperville, IL (US); Jie Yao, Naperville, IL (US)

Correspondence Address: Docket Administrator (Room 3J-219), Lucent Technologies Inc., 101 Crawfords Corner Road, Holmdel, NJ, 07733-3030, US

(21) Appl. No.: 10/108,791

(22) Filed: Mar. 28, 2002

(51) Int. Cl. H04M 3/42

(52) U.S. Cl. 455/414.1; 455/416

(57) ABSTRACT

The present invention provides a method to a wireless station in a wireless communication system. A Mobile Switching Center (MSC) receives a call request for the wireless station. If the MSC determines that the called wireless station is engaged in an existing data call, the MSC alerts the wireless station of the call request while the called station is involved in the existing data call. A user of the mobile station determines if they would like to accept, reject, or forward the call request. The response of the called mobile station is sent to the MSC, which processes the new call request in accordance with the response from the called mobile station. If the called mobile station accepts the call request, the existing data call is placed on hold while the new call is completed.

### FIELD OF THE INVENTION

This invention relates generally to the field of wireless communication systems, and more particularly to processing data calls in wireless communication systems.

### BACKGROUND OF THE INVENTION

Call waiting refers to a service that allows a voice telecommunication system user to receive an indication that a call is incoming while the user is engaged in an existing voice call. The indication is typically in the form of an audible signal, such as a beep, that alerts the user that an incoming call has been received by the telecommunications device. The user can decide to accept the incoming call or not accept the incoming call.

To accept the incoming call, the user typically pushes a button on the telecommunications device, such as the switch hook or a flash button. This action places the existing caller on hold and places the user in an active communication with the new caller. During the time that the new call in continuing, the first caller is on hold. The user can switch back to the first caller, typically by pressing the same key that placed the first caller on hold.

To not accept an incoming call, the user of the telecommunications device can simply take no action. In this case, the new caller will either continue to receive the ringing signal or will be placed in the called party's voice mail system.

In current wireless data communication systems, no such call waiting service is available. A call request that comes to a telecommunications unit that is currently involved in a data call is either rejected by the network or transferred to another endpoint. The call request is not passed to the mobile unit, but is processed by and disposed of by the network without passing the request to the mobile unit. Consequently, the mobile unit is never made aware that a new call has come in during the entire duration of the existing data call. This can lead to difficulties if the wireless data user is anticipating a call while engaged in a data call. This can be especially troublesome if the user is unaware that data incoming call requests are not even routed to wireless units while engaged in data calls.

Therefore, a need exists for a method and apparatus that allows a mobile station that is involved in a data call to receive an indication of an incoming call request. Further, a need exists for a method and apparatus that allows a mobile station to place an existing data call on hold and receive an incoming call.

### BRIEF SUMMARY OF THE INVENTION

The present invention provides a method for handling incoming calls to a wireless phone that is currently engaged in a data call. As used herein, the terms wireless phone, wireless unit, mobile phone, and mobile unit are used interchangeably and refer to a mobile telecommunications unit that accesses a telephone network via a base station or the like via an over-the-air interface. The user of the phone is alerted to the incoming call, and can decide to either place the current data call on hold and accept the incoming call while placing the current data call on hold, and then return to the original data call when the incoming call is complete.

In accordance with an exemplary embodiment of the present invention, the Mobile Switching Center (MSC) does not immediately send a “busy” to a phone calling a wireless phone that is currently engaged in a data call. Rather, the MSC sends a control message to the called mobile station. The called mobile station informs the called user of the second call. The user can then indicate the desired disposition of the second call. In response to the indication from the user, the mobile station sends a control message to the MSC indicating the desired disposition of the second call. The MSC routes or ends the second call, depending on the incoming control message sent from the mobile station. Advantageously, such an arrangement informs the called user of the second incoming call and gives the called user the option of accepting the second call.

### BRIEF DESCRIPTION OF THE SEVERAL VIEWS OF THE DRAWINGS

FIG. 1 depicts a communication system in accordance with the present invention.

FIG. 2 depicts a flow chart of a method for processing, in a wireless network, an incoming call request to a wireless user that is currently involved in a data call in accordance with the present invention.

FIG. 3 depicts a flowchart of a method for processing an incoming call request at a wireless called station while the wireless called station is currently involved in a data call in accordance with the present invention.

### DETAILED DESCRIPTION OF THE INVENTION

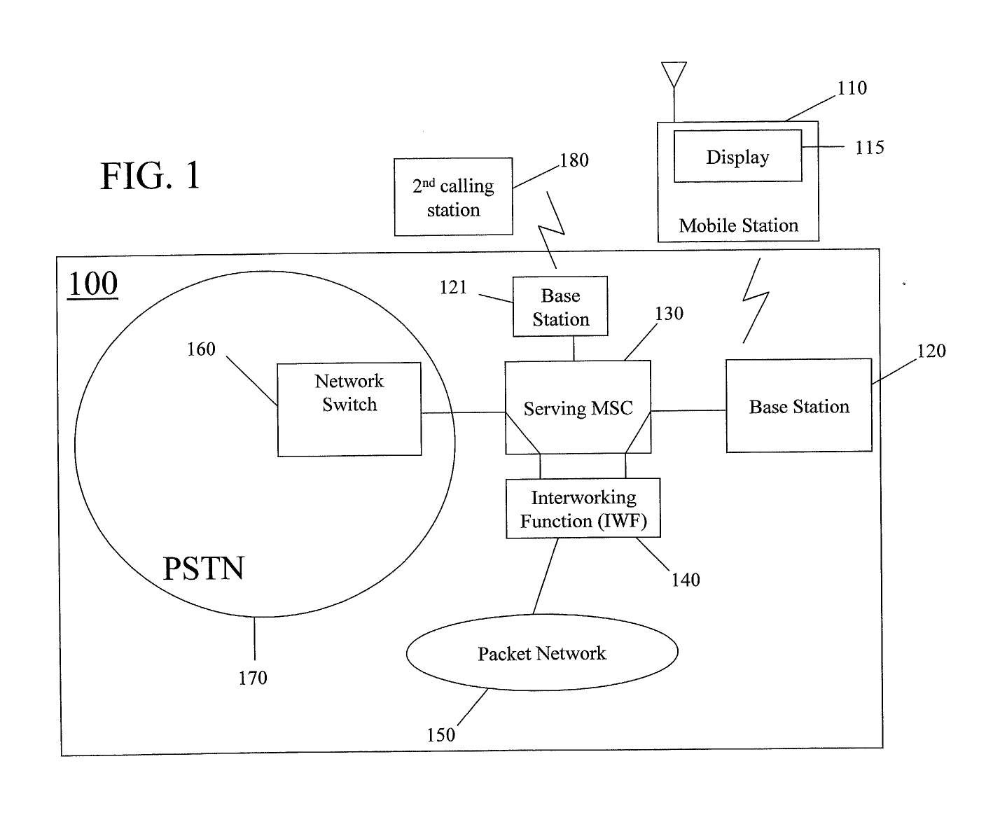

FIG. 1 depicts a communication system 100 in accordance with the present invention. Communication system 100 includes base station 120, serving Mobile Switching Center (MSC) 130, Interworking Function (IWF) 140, packet network 150, and Public Switched Telephone Network (PSTN) 170. IWF 140 connects serving MSC 130 to packet network 150, which allows users connected to packet network 150 to communicate with wireless users associated with serving MSC 130. Base station 120 is coupled to serving MSC 130 and provides over-the-air communication with mobile stations, such as mobile station 110. It should be understood that communication system 100 can include a plurality of MSCs, and each MSC can have a plurality of base stations associated with it. Only one MSC and one base station is depicted in FIG. 1 for clarity. Serving MSC 130 is connected to PSTN 170 via network switch 160. PSTN 170 provides for communication with wireline users.

In the embodiment depicted in FIG. 1, mobile station 110 and second calling station 180 are coupled with and communicating with communication system 100. As depicted in FIG. 1, mobile station 110 is communicating with base station 120 via an over-the-air interface. Second calling station 180 can be either a wireless mobile or a landline telephone (e.g. POTS or ISDN). Second calling station 180 can be coupled to a Base Station via an over the air interface which is technology independent or coupled to a switch in the PSTN. Mobile station 110 includes a display 115 that is used to visually display information to a user of mobile station 110.

In an example of one embodiment of the present invention, Mobile Station 110 is involved in a data call with another end user. The data call can be via either Packet Network (which can include Internet Access) 150 or PSTN 170. During the course of this data call, second calling station 180 initiates a call to Mobile Station 110. As depicted in FIG. 1, second calling station 180 is depicted as being directly connected to Serving MSC 130, but the second caller can be connected to communication system 100 via PSTN 170 or Packet Network 150. Serving MSC 130 alerts Mobile Station 110 of the incoming call request and provides Mobile Station 110 with the identity of the calling party. Mobile Station 110 preferably alerts a user of mobile station 110 that an incoming call request is present, and also displays the identity of the second calling user via display 115.

Responsive to the information on display 115, the user can specify actions to be taken by the network. Such actions can be specified by, for example, depressing a keypad key. In an exemplary embodiment of the present invention, the user can specify the appropriate action to take by depressing a keypad key, but can alternately specify the appropriate action by issuing a voice command or any other method of inputting a command to mobile station 110. Mobile station 110 then informs MSC 130 of the desired action. In accordance with an exemplary embodiment of the present invention, three such actions relating to the new incoming call request can be specified: accepting the call, rejecting the call, or forwarding the second call to another endpoint.

If the user decides to accept the second call, Serving MSC 130 directs Interworking Function 140 to suspend the original data call and connect the second data call from Second Calling Station 180 to Mobile Station 110. After the second received call has been completed, the Serving MSC reconnects the original data call to Mobile Station 110.

If the user decides to reject the second data call, Serving MSC 130 sends a “busy” indication to Second Calling Station 180. If the user decides to forward the second data call to another end point, Serving MSC 130 forwards the second data call to another end point accessed via PSTN 170 or Packet Network 150.

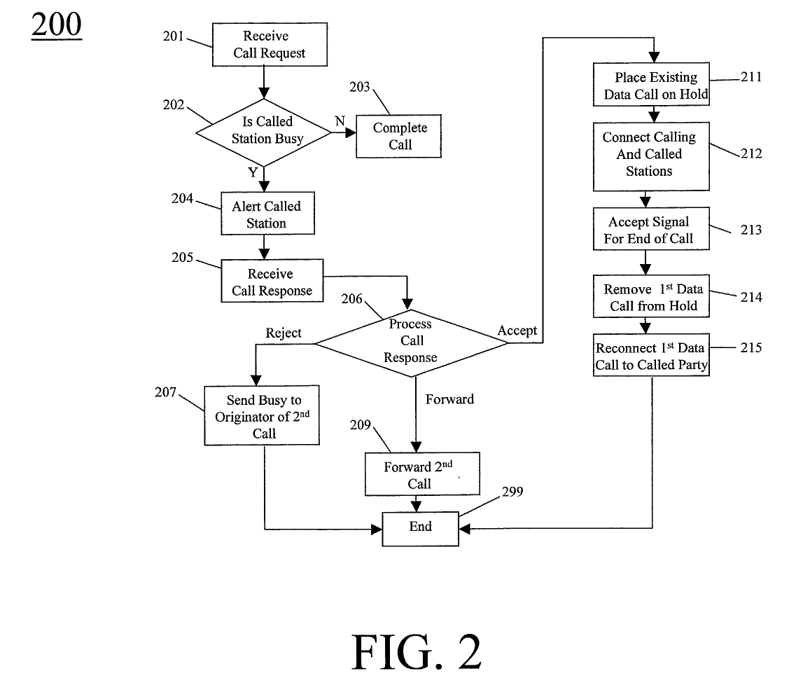

FIG. 2 depicts a flow chart 200 of a method for processing, in a wireless network, a call request to a wireless user that is currently involved in a data call in accordance with the present invention. FIG. 2 depicts the processing that occurs within communication system 100 in accordance with an exemplary embodiment of the present invention.

Communication system 100 receives (201) a call request from an originator. This call request can be originated by a wireline or a wireless user, and can be either a voice call request or a data call request.

Communication system 100 determines (202) if the called station is busy. In accordance with an exemplary embodiment of the present invention, the network determines if the called phone is currently engaged in a wireless data call. If the called station is not busy, communication system 100 completes (203) the new call and the process ends (299).

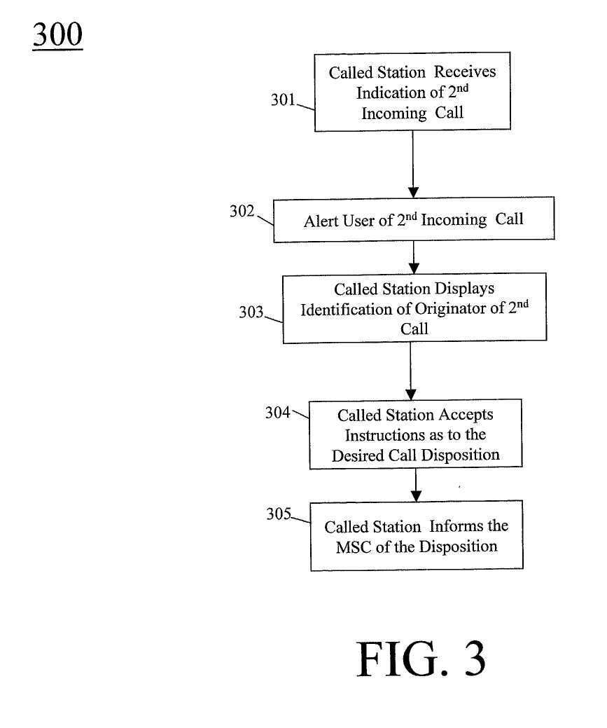

If the called station is busy in a data call, communication system 100 alerts (204) the called station of the incoming call request. The processing performed by the wireless called station is depicted in FIG. 3.

Turning now to FIG. 3, FIG. 3 depicts a flowchart 300 of a method for processing a call request at a wireless called station while the wireless called station is currently involved in a data call in accordance with the present invention. The called station receives (301) an indication of the second incoming call request.

The called station alerts (302) a user of the called station of the second incoming call. The alerting can be done visually, audibly, or via vibration. For example, the alert can be visual by lighting a light on the display of the called station, displaying an icon on the display of the called station, or any other means of displaying something on the display to alert a user of the second incoming data call request. An alert can also be audible, such as a beep, tone, or tune played on the called mobile station. This audible alerting can be done via existing means currently used to cause tones/ringing sequences to be played at a mobile station.

The called station displays (303) the identification of the originator of the second call. This is accomplished via any one of the existing means to display a alphanumeric message on a mobile station.

The called station accepts (304) instructions as to the desired disposition of the second incoming call. As mentioned above, in an exemplary embodiment of the present invention, the desired disposition can be to accept, reject, or forward the second incoming call. The forwarding can be either to a mail server or a different endpoint.

The called station then informs (305) the MSC of the disposition.

Returning now to FIG. 2, communication system 100 receives (205) the call response from the called mobile station. The communication system determines (206) whether the called mobile station wants to accept the call request from the second calling station. This is done by processing the call response received from the called mobile station.

If the called mobile station does not want to accept the call request and thereby rejects the request, communication system 100 sends (207) a busy signal to the second calling station. The process then ends (299).

If the called mobile station indicates that it wants to accept the call request and place the existing data call on hold, communication system 100 places (211) the existing data call on hold. The called mobile station will use existing means, such as flow control, to gracefully stop the data flow on the existing call before that call is placed on hold.

Communication system 100 connects (212) the second calling station and the called mobile station. The call between them continues until the call is complete. Communication system 100 then accepts (213) a signal indicating that the second call has ended.

Communication system 100 removes (214) the first data call from the hold state, and reconnects (215) the first data call between the called mobile station and the first calling station. The process then ends (299).

If the called mobile station wants to forward the call request as determined at step 206, communication system 100 forwards (209) the second call. The forwarding can be to a mail server or a different endpoint. This allows the called party to continue in the ongoing data call but still provide some control over the incoming call request.

The present invention thereby provides a method for completing a call to a mobile station that is currently involved in a data call. By using the present invention, the user can be given the opportunity to accept a second call when that user is already engaged in an existing data call. This is a marked improvement over the current state of the art, which would have the second call automatically killed in the network without notifying the called mobile station of the incoming call request.

While this invention has been described in terms of certain examples thereof, it is not intended that it be limited to the above description, but rather only to the extent set forth in the claims that follow.

We claim:

1. A method of completing a call to a wireless station currently involved in a wireless data call, the method comprising the steps of:
receiving a call request from an originating station for the wireless station;
determining that the wireless station is engaged in an existing data call;
alerting the wireless station of the call request while the wireless station is involved in the existing data call;
receiving a call response from the wireless station; and
processing the call request based upon the call response.

2. A method of completing a call to a wireless station currently involved in a wireless data call in accordance with claim 1, wherein the step of processing the call request comprises rejecting the call request.

3. A method of completing a call to a wireless station currently involved in a wireless data call in accordance with claim 2, wherein the step of rejecting the call request comprises sending a call reject message to the originating station.

4. A method of completing a call to a wireless station currently involved in a wireless data call in accordance with claim 1, wherein the step of processing the call request comprises forwarding the call request to another station.

5. A method of completing a call to a wireless station currently involved in a wireless data call in accordance with claim 4, wherein the step of forwarding the call request comprises sending the call request to another station.

6. A method for completing a call to a wireless station currently involved in a wireless data call in accordance with claim 1, wherein the step of processing the call request comprises accepting the call request.

7. A method of completing a call to a wireless station currently involved in a wireless data call in accordance with claim 6, wherein the step of accepting the call request comprises;
placing the existing data call on hold; and
connecting the originating station to the wireless station.

8. A method of completing a call to a wireless station currently involved in a wireless data call in accordance with claim 7, wherein the step of completing the call comprises accepting a signal of the end of the call.

9. A method of completing a call to a wireless station currently involved in a wireless data call in accordance with claim 8, wherein the step of accepting the signal of the end of the call comprises taking the existing data call off hold.

10. A method of completing a call to a wireless station currently involved in a wireless data call in accordance with claim 9, further comprising reconnecting the existing data call to the wireless station.

11. A method of completing a call to a wireless station currently involved in a wireless data call in accordance with claim 1, wherein the step of alerting the wireless station comprises sending the identity of the originating station to the wireless station.

12. A method of processing an incoming call request for a wireless station currently involved in a wireless data call, the method comprising the steps of:
receiving indication of a second incoming call intended for the wireless station while the wireless station is engaged in an active data call; and
displaying an indication of the second incoming call at the wireless station.

13. A method of processing an incoming call request for a wireless station currently involved in a wireless data call in accordance with claim 12, further comprising the step of generating a call response at the wireless station in response to the second incoming call request.

14. A method of processing an incoming call request for a wireless station currently involved in a wireless data call in accordance with claim 13, the method further comprising sending the call response from the wireless station to a Mobile Switching Center (MSC) associated with the wireless station.

15. A method of processing an incoming call request for a wireless station currently involved in a wireless data call in accordance with claim 14, wherein the step of receiving indication of the second call comprises receiving identification of the originator of the second call.

16. A method of processing an incoming call request for a wireless station currently involved in a wireless data call in accordance with claim 14, wherein the step of displaying an indication of the second call comprises displaying identification of the originator of the second call.
